(19) United States
(12) Patent Application Publication
(10) Pub. No.: US 2026/0181695 A1
(43) Pub. Date: Jun. 25, 2026

(54) DEVICES AND METHODS FOR COORDINATED TRANSMISSION IN A WIRELESS NETWORK

(71) Applicant: HUAWEI TECHNOLOGIES CO., LTD., Shenzhen (CN)

(72) Inventors: Genadiy Tsodik, Hod Hasharon (IL); Arik Klein, Hod Hasharon (IL); Shimon Shilo, Hod Hasharon (IL); Oded Redlich, Hod Hasharon (IL)

(73) Assignee: HUAWEI TECHNOLOGIES CO., LTD., Shenzhen (CN)

(21) Appl. No.: 19/462,445

(22) Filed: Jan. 28, 2026

Related U.S. Application Data
(63) Continuation of application No. PCT/EP2023/071067, filed on Jul. 28, 2023.

(51) Int. Cl. H04W 74/0816

(52) U.S. Cl. CPC H04W 74/0816

(57) ABSTRACT

An access point (AP) configured to gain channel access by participating in a coordinated transmission making use of at least a portion of at least one transmission opportunity (TXOP) obtained and shared by a Sharing AP operating under a coordination agreement and/or within a Multi-AP (M-AP) set of a wireless communication network further including one or more further APs being part of the M-AP set and/or operating under the same coordination agreement. The AP is configured to implement one or more fairness timers, including a first fairness timer and/or a second fairness timer for ensuring a channel access fairness between the AP and the other APs operating under the same coordination agreement within the same M-AP set.

### CROSS-REFERENCE TO RELATED APPLICATIONS

This application is a continuation of International Patent Application No. PCT/EP2023/071067, filed on Jul. 28, 2023, the disclosure of which is hereby incorporated by reference in its entirety.

### TECHNICAL FIELD

The present disclosure relates to wireless communications. More specifically, the present disclosure relates to devices and methods for coordinated transmission in a wireless communication network, in particular an IEEE 802.11-based WLAN.

### BACKGROUND

IEEE 802.11-based WLANs (also referred to as Wi-Fi networks) have become popular at an unprecedented rate. The amendment IEEE 802.11be introduces a Multi-AP (M-AP) coordinated transmission operation, where multiple access points (APs) share resources to allow coordinated transmissions and utilize their resources more efficiently for communicating with non-AP stations (STA). The main principle of M-AP coordination is that an AP obtaining a transmission opportunity (TXOP) may share its resources with other APs. The group of APs that have decided to cooperate and perform coordinated transmissions can be a subset of a M-AP set. The AP sharing the TXOP is also referred to as the AP operating as the Sharing AP (or short “Sharing AP”), while the other APs participating in the coordinated transmission using the TXOP shared by the Sharing AP are also referred to as APs operating as Shared APs (or short “Shared APs”).

In a Wi-Fi network each AP or non-AP station has to maintain a backoff counter (also referred to as Enhanced Distributed Channel Access, EDCA, backoff counter), by means of which the AP or the non-AP station may determine if it obtains the EDCA TXOP to initiate a frame exchange sequence. A set of EDCA channel access rules defined by the IEEE 802.11 standard define: the conditions in which the backoff counter is set to a value; the conditions in which the backoff counter is decremented; and the conditions in which an EDCA TXOP is obtained. Assuming all EDCA channel access rules are maintained by each of the APs in a Wi-Fi network, the APs that participate in a coordinated transmission gain the access to the channel while their EDCA backoff counters remain unchanged. This may lead to unfairness in the Wi-Fi network for APs that do not support M-AP coordinated transmission, since an AP that is participating in the M-AP coordinated transmission may have an increased access to the channel compared to an AP that is not participating in the M-AP coordinated transmission.

### SUMMARY

The present disclosure provides devices and methods for AP coordinated transmission in a wireless communication network, in particular an IEEE 802.11 based WLAN, while keeping the fairness of the access to the channel.

According to a first aspect, an access point, AP, is configured to gain channel access by participating in a coordinated transmission making use of at least a portion of at least one transmission opportunity, TXOP, obtained and shared by a Sharing AP, i.e. an AP operating as a Sharing AP, wherein the AP and the Sharing AP operate under a coordination agreement and/or within a Multi-AP, M-AP, set of a wireless, in particular Wi-Fi communication network further including one or more first further APs operating under the same coordination agreement and/or being part of the M-AP set. The AP is configured to implement one or more fairness timers, including a first fairness timer (herein also referred to as M-APInterSetTimer) for ensuring a channel access fairness between the AP and one or more second further APs operating on the same channel but not being part of the M-AP set or part of the same coordination agreement or another coordination agreement and/or a second fairness timer (herein also referred to as M-APIntraSetTimer) for ensuring a channel access fairness between the AP and the first further APs operating under the same coordination agreement and/or being part of the same M-AP set. Thus, an AP is provided for coordinated transmission in a wireless communication network, in particular an IEEE 802.11 based WLAN, allowing to maintain the channel access fairness and, consequently, a reduced collision rate within the wireless communication network.

In a further possible implementation form, the AP is configured to implement the first fairness timer after being shared for a coordinated transmission by the AP, operating as the Sharing AP, that has obtained the TXOP for ensuring the channel access fairness between AP and the one or more second further APs operating on the same channel but not being part of the M-AP set or part of the same coordination agreement or another coordination agreement and wherein the AP is configured to wait for the first fairness timer to end, i.e. expire before resuming competing for gaining the channel access.

In a further possible implementation form, the AP is configured to wait for the first fairness timer to end, i.e. expire before resuming competing for gaining channel access by resuming an EDCA backoff counter.

In a further possible implementation form, the first fairness timer is defined in units of time.

In a further possible implementation form, the AP is configured to implement the second timer for ensuring the channel access fairness between AP and the first further APs operating under the same coordination and/or being part of the M-AP set that are shared by the AP, operating as the Sharing AP, wherein the AP is configured to wait for the second timer to end, i.e. expire before participating in another subsequent M-AP coordinated transmission within the M-AP set or under the same coordination agreement within the M-AP set.

In a further possible implementation form, the second timer is defined in units of time.

In a further possible implementation form, the second timer is defined in units of TXOPs.

In a further possible implementation form, the AP is configured to count down the second timer defined in units of TXOPs by decrementing the second timer by one each time the TXOP is held by the one or more of the first further APs in the M-AP set or operating under the same coordination agreement within the M-AP set.

In a further possible implementation form, the AP is configured to start the first timer and/or the second timer at the end of the TXOP.

In a further possible implementation form, the AP is configured to receive a PPDU from the AP, operating as the Sharing AP, i.e. the AP that has obtained the TXOP, wherein the PPDU comprises an indication, in particular a Duration field value, of the duration of the TXOP, to start the first timer and/or the second timer.

In a further possible implementation form, the AP is configured to be triggered by the AP, operating as the Sharing AP, i.e. the AP that has obtained the TXOP, to transmit at least one PPDU as a coordinated transmission, wherein the AP is configured to start the first timer and/or the second timer at the end of the at least one PPDU.

In a further possible implementation form, the AP is configured to restart the first timer and/or the second timer, if the AP is triggered by the AP, operating as the Sharing AP, i.e. the AP that has obtained the TXOP, to transmit at least one further PPDU as a coordinated transmission.

In a further possible implementation form, the AP is configured to receive a frame from the AP, operating as the Sharing AP, wherein the frame indicates the AP to start the first timer and/or the second timer at the end of the frame.

In a further possible implementation form, the frame comprises one or more identifiers indicative of the AP and/or one or more of the first further APs in the M-AP set and/or operating under the same coordination agreement within the M-AP set requested and/or required to start the first timer and/or the second timer at the end of the frame.

In a further possible implementation form, the first timer and/or the second timer are defined by the coordination agreement under which this AP is operating.

In a further possible implementation form, prior to or at the beginning of the TXOP the AP is configured to receive a frame from the AP, operating as the Sharing AP, i.e. the AP which has obtained the TXOP, wherein the frame comprises an indication for the AP whether to count for the second timer before participating in another subsequent M-AP coordinated transmission initiated by any AP operating under the same coordination agreement within the M-AP set or operating in the same M-AP set as the AP, i.e. whether or not to apply the second timer. In an implementation form the indication may be a single bit, e.g. a flag bit, which may be part of the M-AP announcement frame transmitted by the AP, operating as the Sharing AP, at the beginning of the TXOP the AP, operating as the Sharing AP, has obtained.

In a further possible implementation form, the ratio between the values of the first timer and the second timer or the ratio between the values of the second timer and the first timer is defined by a fairness factor.

In a further possible implementation form, the fairness factor has a value of 1 or greater or the fairness parameter is within the range from 0 to 1, i.e. including the boundary values of 0 and 1.

In a further possible implementation form, the AP is configured to receive a frame that contains a M-AP EDCA information element from the AP, operating as the Sharing AP, within the same M-AP set, wherein the M-AP EDCA information element comprises one or more parameters, including: the first timer; the second timer; the fairness factor; a minimum size of a M-AP contention window; a maximum size of a M-AP contention window; a M-AP Arbitration Interframe Space Number, AIFSN; and/or a timer initializing point.

In a further possible implementation form, the AP is configured to derive the M-AP EDCA information element as an inclusive part of the frame that contains the coordination agreement and transmitted by the AP, operating as the Sharing AP, wherein the one or more parameters of the M-AP Information element are valid for the duration of the coordination agreement.

In a further possible implementation form, the AP is configured to derive the M-AP EDCA information element as an inclusive part of the M-AP announcement frame transmitted by the AP, operating as the sharing AP, wherein the one or more parameters of the M-AP Information element are valid for the current TXOP.

In a further possible implementation form, the AP is configured to send information to the AP, operating as the Sharing AP, operating under the same coordination agreement within the M-AP set indicative of whether the second timer has already expired or not, so that the AP, operating as the Sharing AP, is aware for potential APs that can potentially participate in the next M-AP coordination transmission (as Shared APs).

In a further possible implementation form, the AP is configured to send a M-AP timer status response frame to the AP, operating as the Sharing AP, operating under the same coordination agreement within the M-AP set, including the information indicative of whether the second timer has already expired or not, in response to receiving a M-AP timer status poll frame and/or a M-AP announcement frame, aggregated with a M-AP timer status poll frame transmitted by the AP, operating as the Sharing AP.

In a further possible implementation form, the M-AP timer status poll frame and/or the M-AP announcement frame comprises a M-AP set identifier indicative of the M-AP set.

In a further possible implementation form, the M-AP timer status poll frame and/or the M-AP announcement frame comprises a coordination agreement identifier within the M-AP set, wherein the coordination agreement identifier identifies one coordination agreement of a plurality of coordination agreements within the M-AP set and wherein the AP, operating as the sharing AP, and the AP operate under the coordination agreement identified by the coordination agreement identifier within the M-AP set.

In a further possible implementation form, the M-AP timer status poll frame and/or the M-AP announcement frame comprises an identifier of the AP and/or one or more identifiers of the one or more first further APs of the M-AP set or operating under the same coordination agreement within the M-AP set indicative of the APs requested to send a M-AP timers status response to the sharing AP.

In a further possible implementation form, the AP is configured to send the M-AP timer status response frame to the AP, operating as the Sharing AP, operating under the same coordination agreement within the M-AP set irrespective of whether the first fairness timer and/or the second fairness timer has ended.

According to a second aspect a method is provided for operating an access point, AP, configured to gain channel access by participating in a coordinated transmission making use of at least a portion of at least one transmission opportunity, TXOP, obtained and shared by an AP, operating as a Sharing AP, operating under a coordination agreement and/or within a Multi-AP, M-AP, set of a wireless, in particular Wi-Fi communication network further including one or more first further APs being part of the M-AP set and/or operating under the coordination agreement, wherein the method comprises implementing one or more fairness timers, including a first timer for ensuring a channel access fairness between the AP and one or more second further APs operating on the same channel but not being part of the M-AP set or part of the coordination agreement or another coordination agreement and/or a second timer for ensuring a channel access fairness between the AP and the one or more first further APs operating under the same coordination agreement within the same M-AP set.

The method according to the second aspect of the present disclosure can be performed by the AP according to the first aspect of the present disclosure. Thus, further features of the method according to the second aspect of the present disclosure result directly from the functionality of the AP according to the first aspect of the present disclosure as well as its different implementation forms described above and below.

According to a third aspect an AP, operating as a sharing AP, is provided, wherein the AP, operating as the Sharing AP, is configured to manage channel access by one or more further APs by participating in a coordinated transmission making use of at least a portion of at least one transmission opportunity, TXOP, obtained and shared by the AP, operating as the Sharing AP, operating under a coordination agreement and/or within a Multi-AP, M-AP, set of a wireless, in particular Wi-Fi communication network, wherein each of the one or more further APs is configured to implement one or more fairness timers, including a first fairness timer for ensuring a channel access fairness between the AP and one or more second further APs operating on the same channel but not being part of the M-AP set or part of the coordination agreement and/or a second fairness timer for ensuring a channel access fairness between the AP and the one or more first further APs operating under the same coordination agreement within the same M-AP set, wherein the AP, operating as the Sharing AP, is configured to send a M-AP timer status poll frame and/or a M-AP announcement frame aggregated with a M-AP timer status poll frame to the one or more first further APs for requesting information about the second fairness timer, e.g. about the status of the second fairness timer.

In a further possible implementation form, the M-AP timer status poll frame and/or the M-AP announcement frame comprises a M-AP set identifier indicative of the M-AP set.

In a further possible implementation form, the M-AP timer status poll frame and/or the M-AP announcement frame comprises a coordination agreement identifier within the M-AP set, wherein the coordination agreement identifier identifies one coordination agreement of a plurality of coordination agreements within the M-AP set and wherein the AP, operating as the Sharing AP, and the one or more first further APs operate under the coordination agreement identified by the coordination agreement identifier within the M-AP set.

In a further possible implementation form, the M-AP timer status poll frame and/or the M-AP announcement frame comprises one or more identifiers of the one or more first further APs of the M-AP set or operating under the same coordination agreement within the M-AP set indicative of the APs requested to send a M-AP timer status response frame to the AP, operating as the Sharing AP.

In a further possible implementation form, the AP, operating as the Sharing AP, is configured to receive a M-AP timer status response frame from the one or more first further APs, wherein the M-AP timer status response frame comprises information about the second fairness timer.

In a further possible implementation form, the AP, operating as the Sharing AP, is configured to send an indication to the one or more first further APs for setting the second fairness timer of each of the one or more first further APs to zero for the current TXOP.

In a further possible implementation form, the AP, operating as the Sharing AP, is configured to send a M-AP announcement frame to the one or more first further APs, wherein the M-AP announcement frame comprises the indication for setting the second timer of each of the one or more first further APs to zero for the current TXOP.

In a further possible implementation form, the AP, operating as the Sharing AP, is configured to send a frame containing a M-AP EDCA information element to the one or more first further APs within the M-AP set, wherein the M-AP EDCA information element comprises one or more parameters, including: the first fairness timer; the second fairness timer; a fairness factor defined by the ratio between the first fairness timer and the second fairness timer; a minimum size of a M-AP contention window; a maximum size of a M-AP contention window; a M-AP Arbitration Interframe Space Number, AIFSN; and/or a fairness timer initializing point.

In a further possible implementation form, the AP, operating as the Sharing AP, is configured to generate a new backoff counter value based on the minimum size and the maximum size of the M-AP contention window, once the AP, operating as the Sharing AP, has completed the M-AP coordinated transmission for the at least one TXOP.

According to a fourth aspect a method of operating an AP, operating as a Sharing AP, is provided, wherein the AP, operating as the Sharing AP, is configured to manage channel access of one or more first further APs by participating in a coordinated transmission making use of at least a portion of at least one transmission opportunity, TXOP, obtained and shared by the AP, operating as the Sharing AP, operating under a coordination agreement and/or within a Multi-AP, M-AP, set of a wireless, in particular Wi-Fi communication network, wherein each of the one or more first further APs is configured to implement one or more fairness timers, including a first fairness timer for ensuring a channel access fairness between the respective first further AP and one or more second further APs operating on the same channel but not being part of the M-AP set or part of the coordination agreement and/or a second fairness timer for ensuring a channel access fairness between the respective first further AP and the other first further APs operating under the same coordination agreement within the same M-AP set. The method comprises sending a M-AP timer status poll frame and/or a M-AP announcement frame aggregated with a M-AP timer status poll frame to the one or more first further APs for requesting information about a status of the second fairness timer.

The method according to the fourth aspect of the present disclosure can be performed by the AP, operating as the Sharing AP, according to the third aspect of the present disclosure. Thus, further features of the method according to the fourth aspect of the present disclosure result directly from the functionality of the AP, operating as the Sharing AP, according to the third aspect of the present disclosure as well as its different implementation forms described above and below.

According to a fifth aspect, a computer program product, comprising a computer-readable storage medium for storing program code which causes a computer or a processor to perform the method of the second aspect or the method of the fourth aspect when the program code is executed by the computer or the processor, is provided.

Details of one or more embodiments are set forth in the accompanying drawings and the description below. Other features, objects, and advantages will be apparent from the description, drawings, and claims.

### BRIEF DESCRIPTION OF THE DRAWINGS

In the following, embodiments of the present disclosure are described in more detail with reference to the attached figures and drawings, in which:

FIG. 1 shows a schematic diagram of an exemplary wireless communication network including a sharing AP and a plurality of shared APs in a M-AP set or under a coordination agreement within the same M-AP set for M-AP coordinated transmission and a plurality of APs that are not part of M-AP set or under a coordination agreement within the same M-AP set, according to an embodiment implementing one or more channel access fairness timers;

FIG. 2 shows a timing diagram illustrating the coordinated transmission of several APs of the wireless communication network of FIG. 1 for three transmission opportunities making use of channel access fairness timers according to an embodiment;

FIG. 3 shows a timing diagram illustrating a frame exchange between several APs of the wireless communication network of FIG. 1 for obtaining information about one or more channel access fairness timers according to an embodiment;

FIG. 4 shows a flow diagram illustrating a method of operating an AP operating as a Shared AP in a M-AP coordinated transmission by a Sharing AP that is operating under the same coordination agreement within the M-AP set according to an embodiment;

FIG. 5 is a flow diagram illustrating a method of operating an AP, operating as a Sharing AP, according to an embodiment;

FIG. 6 is a diagram illustrating the channel access ratio for a group of APs implementing one or more channel access fairness timers according to an embodiment;

FIG. 7 shows graphs illustrating the cumulative distribution function, CDF, of the collision rate for a group of APs implementing one or more channel access fairness timers according to an embodiment; and

FIG. 8 is a diagram illustrating the channel access ratio for a group of APs implementing one or more channel access fairness timers according to an embodiment.

In the following, identical reference signs refer to identical or at least functionally equivalent features.

### DETAILED DESCRIPTION OF THE EMBODIMENTS

In the following description, reference is made to the accompanying figures, which form part of the disclosure, and which show, by way of illustration, specific aspects of embodiments of the present disclosure or specific aspects in which embodiments of the present disclosure may be used. It is understood that embodiments of the present disclosure may be used in other aspects and comprise structural or logical changes not depicted in the figures. The following detailed description, therefore, is not to be taken in a limiting sense, and the scope of the present disclosure is defined by the appended claims.

For instance, it is to be understood that a disclosure in connection with a described method may also hold true for a corresponding device or system configured to perform the method and vice versa. For example, if one or a plurality of specific method steps are described, a corresponding device may include one or a plurality of units, e.g. functional units, to perform the described one or plurality of method steps (e.g. one unit performing the one or plurality of steps, or a plurality of units each performing one or more of the plurality of steps), even if such one or more units are not explicitly described or illustrated in the figures. On the other hand, for example, if a specific apparatus is described based on one or a plurality of units, e.g. functional units, a corresponding method may include one step to perform the functionality of the one or plurality of units (e.g. one step performing the functionality of the one or plurality of units, or a plurality of steps each performing the functionality of one or more of the plurality of units), even if such one or plurality of steps are not explicitly described or illustrated in the figures. Further, it is understood that the features of the various exemplary embodiments and/or aspects described herein may be combined with each other, unless specifically noted otherwise.

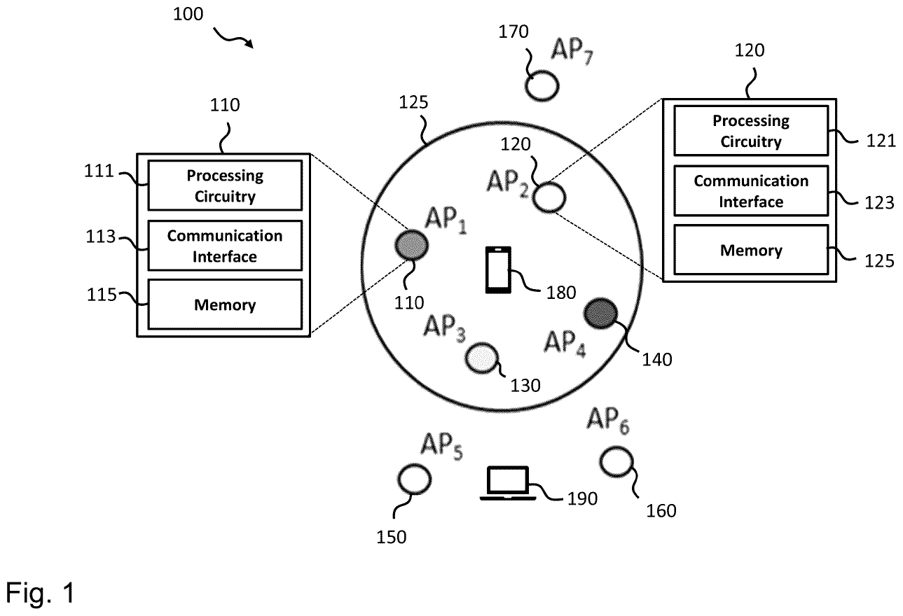

FIG. 1 shows an exemplary wireless communication network 100 including a plurality of access points, APs, 110-170. The embodiment shown in FIG. 1 might be exemplary for an enterprise implementation, where the plurality of APs 110-170 provide connectivity to a plurality of non-AP stations (also referred to as non-AP STAs). In the exemplary scenario of FIG. 1 only two exemplary non-AP stations 180, 190 are shown as examples for a plurality of non-AP stations, for instance, more seven or more non-AP stations, which may include mobile phones, laptop computers, tablet computers or other types of smart IoT devices. As will be appreciated, each AP 110-170 may provide connectivity to the plurality of non-AP stations, such as the non-AP stations 180, 190, once a respective non-AP station is associated to a respective AP 110-170. In an embodiment, the wireless communication network 100 is a WLAN in accordance with the IEEE 802.11 framework of standards (also referred to as a Wi-Fi network 100).

In the exemplary scenario the APs 110, 120, 130 and 140 are part of a Multi-AP, i.e. M-AP set 125 (as indicated by the circle), while the APs 150, 160 and 170 are not part of the M-AP set 125. The concept of a M-AP set, such as the M-AP set 125 of FIG. 1, has been discussed in the context of a M-AP coordinated transmission operation, where multiple APs share resources to allow parallel transmissions and utilize their resources more efficiently for communicating with non-AP stations (STA). The main principle of M-AP coordinated transmission is that an AP which has obtained a transmission opportunity (TXOP) may share its resources with other OBSS APs in order to create a coordinated transmission of the OBSS APs. The group of APs that have decided to cooperate and perform coordinated transmissions can be a subset of a M-AP set. The AP sharing the TXOP is also referred to as the AP, operating as the Sharing AP (or short “Sharing AP”), while the other APs participating in the coordinated transmission using the TXOP shared by the Sharing AP are also referred to as APs, operating as Shared APs (or short “Shared APs”). The M-AP set, i.e. the group of APs may decide on one or more specific coordination agreements defining, for instance, a respective set of parameters for the coordinated transmission of the APs of the M-AP set.

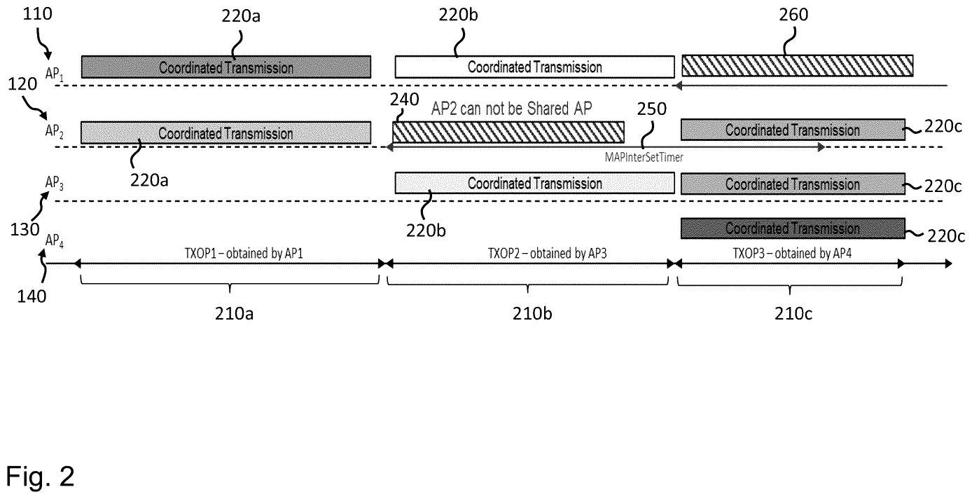

In the following description of detailed embodiments, the AP 110 is operating as the Sharing AP and therefore will be also referred to as the AP operating as the sharing AP 110 (or short “Sharing AP 110”), while the AP 120 and possibly one or more of the other APs 130, 140 of the M-AP set 125 are operating as a Shared AP and therefore will be also referred to as APs operating as Shared APs (or short “Shared APs”) 120, 130, 140. As will be appreciated, however, while for a first TXOP the AP 110 may be the AP operating as the Sharing AP and, for instance, the AP 120 may be an AP operating as a Shared AP, for a further TXOP these roles may be reversed, i.e. the AP 110 may be an AP operating as a Shared AP, while the AP 120 may be the AP operating as the Sharing AP, as will be described in more detail below in the context of the example shown in FIG. 2. Thus, as will be further appreciated, being the Sharing AP or the Sharing AP may be considered as different operation modes or roles each of the APs of a M-AP set may assume temporarily. In other words, the same physical AP, such as the AP 110 or the AP 120, may be a Sharing AP during certain times and a Shared AP during other times.

As illustrated in FIG. 1, the Sharing AP 110 may comprise a processing circuitry 111 and a communication interface 113, in particular a wireless communication interface 113 in accordance with the IEEE 802.11 framework of standards. The processing circuitry 111 may be implemented in hardware and/or software and may comprise digital circuitry, or both analog and digital circuitry. Digital circuitry may comprise components such as application-specific integrated circuits (ASICs), field-programmable gate arrays (FPGAs), digital signal processors (DSPs), or general-purpose processors. The Sharing AP 110 may further comprise a memory 115 configured to store executable program code which, when executed by the processing circuitry 111, causes the Sharing AP 110 to perform the functions and methods described herein.

Likewise, the Shared AP 120 illustrated in FIG. 1 (as an example for the other APs shown in FIG. 1) may comprises a processing circuitry 121 and a communication interface 123, in particular a wireless communication interface 123 in accordance with the IEEE 802.11 framework of standards. The processing circuitry 121 may be implemented in hardware and/or software and may comprise digital circuitry, or both analog and digital circuitry. Digital circuitry may comprise components such as application-specific integrated circuits (ASICs), field-programmable gate arrays (FPGAs), digital signal processors (DSPs), or general-purpose processors. The Shared AP 120 may further comprise a memory 125 configured to store executable program code which, when executed by the processing circuitry 121, causes the exemplary Shared AP 120 to perform the functions and methods described herein.

According to embodiments disclosed herein the plurality of APs of the Wi-Fi network 100, in particular the APs 110, 120, 130 and 140 of the M-AP set 125 are configured, if being operated as a Shared AP, such that an Inter Set Fairness (i.e. a fairness of the APs of the M-AP set 125 with other APs not belonging to the M-AP set 125 or coordination agreement within the M-AP set 125, such as the APs 150, 160, 170) and/or an Intra Set Fairness (i.e. a fairness of the APs within the M-AP set 125) is observed within the Wi-Fi network 100, as will be described in more detail in the following. The Inter Set Fairness as implemented by embodiments disclosed herein allows to preserve the fairness among all the OBSS APs, not only those operating as part of a M-AP coordinated transmission. In other words, according to embodiments disclosed herein being part of M-AP set and/or coordination agreement does not increase the probability of an OBSS AP to gain access to the channel compared with any other OBSS AP in the Wi-Fi network 100.

The Intra Set Fairness as implemented by embodiments disclosed herein is based on the assumption that the sharing method of the APs that participate in a M-AP coordinated transmission might be flexible so not all the APs within a M-AP set or operating under the same coordination agreement within a M-AP set are shared within every TXOP obtained by any member AP of the M-AP set or operating under the same coordination agreement within a M-AP set. Each AP may implement its own algorithm for selecting Shared APs and it cannot be ensured that all the algorithms provide equal probability for all the APs within the M-AP set or operating under the same coordination agreement within a M-AP set to be selected as a Shared AP. Such a non-equal probability may cause APs to leave the M-AP set or to tear down the coordination agreement that have joined and may reduce M-AP coordinated transmission gain. Therefore, the Intra Set Fairness as implemented by embodiments disclosed herein ensures that every AP within the M-AP set or operating under the same coordination agreement within a M-AP set, such as the APs 110, 120, 130, 140 of the M-AP set 125, and/or the coordination agreement has a similar probability to become a Shared AP.

To this end, embodiments disclosed herein provide new parameters and rules for the Inter Set Fairness and/or the Intra Set Fairness regarding a M-AP coordinated transmission. In the following, these embodiments will be described in the context of FIG. 2 and the exemplary Shared AP 120 of the M-AP set 125. As will be appreciated and already mentioned above, however, these embodiments apply to the other APs 110, 130, 140 in the M-AP set 125 as well.

For communicating with its associated non-AP STAs, such as the non-AP STA 180, the AP 120 is configured to gain channel access by participating in a coordinated transmission 220a making use of at least a portion of at least one transmission opportunity, TXOP, 210a obtained and shared by the exemplary Sharing AP 110 operating under a coordination agreement within the M-AP set 125 and/or within the M-AP set 125 of the wireless communication network, in particular Wi-Fi network 100. From the perspective of the Shared AP 120, the exemplary Wi-Fi network 100 illustrated in FIG. 1 includes one or more first further APs being part of the M-AP set 125 and/or operating under the same coordination agreement within the M-AP set 125, namely the APs 130, 140, and one or more second further APs operating on the same channel but not being part of the M-AP set 125 or part of the same coordination agreement within the M-AP set 125, namely the APs 150, 160, 170. As will be described in more detail in the following, the AP 120, for instance, by means of its processing circuitry 121 is configured to implement one or more fairness timers, including (a) a first fairness timer (herein also referred to as M-APInterSetTimer) for ensuring a channel access fairness between the AP 120 and the one or more second further APs 150, 160, 170 operating on the same channel but not being part of the M-AP set 125 or part of the same coordination agreement within the M-AP set 125 and/or (b) a second fairness timer (herein also referred to as M-APIntraSetTimer) for ensuring a channel access fairness between the AP 120 and the one or more first further APs 130, 140 operating under the same coordination agreement within the M-AP set 125.

In an embodiment, the AP 120, in particular the processing circuitry 121 thereof is configured to wait for the first fairness timer, i.e. the M-APInterSetTimer, to end before resuming competing for gaining channel access by resuming an Enhanced Distributed Channel Access, EDCA, backoff counter, as defined by the IEEE 802.11 framework of standards. In other words, in an embodiment, the first fairness timer defines the period, i.e. duration when the AP 120 should hold the EDCA backoff counter.

In an embodiment, the AP 120 in particular the processing circuitry 121 thereof is configured to wait for the second fairness timer, i.e. the M-APIntraSetTimer, to end before participating in another coordinated transmission within the M-AP set 125 or under the same coordination agreement within the M-AP set 125. In other words, in an embodiment, the second fairness timer defines the period when the AP 120 cannot operate as a Shared AP (i.e. cannot assume the role of a Shared AP) in another TXOP which includes a coordinated transmission.

Thus, based on the embodiments disclosed above, the Shared AP 120 that has gained channel access using a M-AP coordinated transmission may be configured to wait for the period, i.e. duration defined by the M-APInterSetTimer before the Shared AP 120 resumes its backoff counter and/or to wait for the period, i.e. duration defined by the M-APIntraSetTimer before the Shared AP 120 may participate in another M-AP coordinated transmission within the M-AP set 125. In a further embodiment, the AP that is used either as a Shared AP 120 or as a Sharing AP 110 may update the CWmin/CWmax values, defined in accordance with the IEEE 802.11 framework of standards, for generating new backoff counter values in order to gain the channel access for the next M-AP coordinated transmission.

In order to further illustrate the embodiments described above FIG. 2 shows a timing diagram illustrating coordinated transmissions of the APs 110, 120, 130, 140, which, as illustrated in FIG. 1, define the M-AP set 125 or a coordination agreement within the M-AP set 125 of the Wi-Fi network 100. As already described above, the APs 110, 120, 130, 140 of the M-AP set 125 or a coordination agreement within the M-AP set 125 may have established a M-AP coordination agreement, which may define, by way of example, that the second timer, i.e. the M-APIntraSetTimer value equals half of the first timer, i.e. M-APInterSetTimer value. Thus, in this exemplary embodiment, for the period of 0.5*M-APInterSetTimer value, any Shared AP 120, 130, 140 that has participated in a M-AP coordinated transmission 220a (and gained an access to the channel) cannot become a Shared AP in another TXOP that is obtained by any member of this M-AP coordination agreement which occurs within the period of the first timer, i.e. M-APInterSetTimer.

By way of example, the timing diagram of FIG. 2 shows three transmission opportunities 210a-c, namely a first transmission opportunity TXOP1 210a, a second transmission opportunity TXOP2 210b and a third transmission opportunity TXOP3 210c. The AP 110 is the holder, i.e. the Sharing AP 110 for the first TXPO1 210a and the AP 110 shares its resources with the AP 120, i.e. the Shared AP 120 during the M-AP coordinated transmission 220a. In accordance with the embodiments described above at the end of the first TXOP1 210a the AP 120 has to wait for the M-APInterSetTimer 250 before the AP 120 may continue counting its back off. In addition, the AP 120 is configured to avoid becoming a Shared AP for the M-APIntraSetTimer 240, i.e. for the period of 0.5*M-APInterSetTimer (as defined by the M-AP coordination agreement established by the APs 110, 120).

For the second TXOP2 210b the AP 130 is the TXOP holder, i.e. the Sharing AP, and it shares its resources in the coordinated transmission 220b with the AP 110, but not with the AP 120, because the M-APIntraSetTimer 240 of the AP 120 has not expired yet. For the third TXOP3 210c the AP 140 is the TXOP holder, i.e. the Sharing AP, and it shares its resources in the coordinated transmission with the AP 120 (for which the M-APIntraSetTimer 240 has expired by now) and the AP 130, but not with AP 110, because the M-APIntraSetTimer 260 of the AP 110 has not expired yet. As will be appreciated, the example shown in FIG. 2 is only for illustrative purposes and the time periods shown here might be different in an actual operation of the WLAN network 100 according to an embodiment in practice.

In an embodiment, the first fairness timer, i.e. the M-APInterSetTimer 250 (or more specifically the duration thereof) may be defined in units of time (e.g. microseconds, TU). In an embodiment, the second fairness timer, i.e. the M-APIntraSetTimer 240, 260 may be defined in units of time as well. Alternatively, the second fairness timer may be defined in integer units of a TXOP, such as M-APIntraSetTimer=1*TXOP.

In an embodiment, the processing circuitry 121 of the AP 120 may be configured to initialize, i.e. start counting the first fairness timer 250 and/or the second fairness timer 240, 260 at the end of the TXOP, where the AP 120 participated as Shared AP. In an embodiment, this information may be provided in a duration field of a first PPDU sent by the Sharing AP 110 for the coordinated transmission during its TXOP.

In a further embodiment, the processing circuitry 121 of the AP 120 may be configured to initialize, i.e. start counting the first fairness timer 250 and/or the second fairness timer 240, 260 at the end of the last PPDU transmitted as a coordinated transmission triggered by the Sharing AP 110 where the AP 120 has participated as a Shared AP (in this case, the AP 120 may restart the first and/or second fairness timer 240, 250, 260 at the end of each PPDU transmitted during the M-AP coordinated transmission triggered by the Sharing AP 110, where the AP 120 is participating as a Shared AP.

In a further embodiment, the processing circuitry 121 of the AP 120 may be configured to initialize, i.e. start counting the first fairness timer 250 and/or the second fairness timer 240, 260 based on dedicated information transmitted by the Sharing AP 110. For instance, in an embodiment, the Sharing AP 110 may transmit a frame that includes an indication that the first and/or second fairness timers 240, 250, 260 should be started at the end of current frame. In an embodiment, such a frame provided by the Sharing AP 110 may include a respective indication (such as an identifier or an address) of specific APs 120, 130, 140 that need to start their first and/or second fairness timers 240, 250, 260 and/or an indication triggering all the Shared APs 120, 130, 140 of the M-AP Set 125 or a specific coordination agreement thereof to start their first and/or second fairness timers 240, 250, 260.

In an embodiment, each Shared AP 120, 130, 140 that has participated in a coordinated transmission triggered by the Sharing AP 110 may count its first and/or second M-AP fairness timers 240, 250, 260 in accordance with one or more of the following rules. The Shared AP 120, 130, 140 may count the first fairness timer, i.e. the M-APInterSetTimer 250 continuously starting from the initialization point (i.e. starting point) until the timer reaches zero (as already described above, in an embodiment the first fairness timer, i.e. the M-APInterSetTimer 250 is defined in units of time, for instance, microseconds). In case the second fairness timer, i.e. the M-APIntraSetTimer 240, 260 is defined in units of time as well, the Shared AP 120, 130, 140 may count the second fairness timer, i.e. the M-APIntraSetTimer 240, 260 continuously starting from the initialization point (i.e. starting point) until the timer reaches zero. In the alternative case that the second fairness timer, i.e. the M-APIntraSetTimer 240, 260 is defined in integer units of TXOP, the Shared AP 120, 130, 140 may be configured to decrement the second fairness timer, i.e. the M-APIntraSetTimer 240, 260 by one each time a TXOP is owned by an AP from the same M-AP set 125 or operating under the same coordination agreement within the M-AP set 125.

In some particular scenarios, e.g. for some particular TXOPs the restriction for being a Shared AP may be relaxed. For example, if all the APs 110, 120, 130, 140 within the M-AP set 125 and/or a coordination agreement thereof are being shared in a specific TXOP, there is no reason to prevent any of them from being shared in the next TXOP obtained by any AP 110, 120, 130, 140 that is a member of the M-AP set 125 and/or a coordination agreement within the M-AP set 125 (since there is no fairness issue among Shared APs within a specific M-AP coordination agreement).

Thus, in order to allow operating in a dynamic environment in an embodiment an indication may be added for the Sharing AP at the beginning of a TXOP indicative of whether (a) the restriction regarding participation in a coordinated transmission (as set as part of the coordination agreement) should be applied after the current TXOP has ended, i.e. to use the second fairness timer, i.e. the M-APIntraSetTimer 240, 260 as is defined in the coordination agreement or whether (b) the second fairness timer, i.e. the M-APIntraSetTimer 240, 260 should be set to zero for current TXOP after the current TXOP has ended. In an embodiment, this indication may comprise a single indication, i.e. flag bit. In an embodiment, the indication, e.g. the flag bit may be added by the Sharing AP 110 to a M-AP Announcement Frame (transmitted by the Sharing AP at the beginning of the TXOP it obtains).

As already described above in the context of FIG. 2, in an embodiment, the first fairness timer, i.e. the M-APInterSetTimer 250 and the second fairness timer, i.e. the M-APIntraSetTimer 240, 260 may be correlated, e.g. for instance by a relation such as M-APInterSetTimer=0.5*M-APInterSetTimer. Based on such a correlation the APs of the M-AP set 125 may make use of a M-APFairnessFactor, as will be described in more detail in the following.

As already described above, in an embodiment, the first fairness timer, i.e. the M-APInterSetTimer 250 defines the period during which the respective Shared AP is configured to hold, i.e. freeze its EDCA backoff counter. In an embodiment, the M-APFairnessFactor may be defined as the ratio between the M-APIntraSetTimer and the M-APInterSetTimer, i.e. M-APFairnessFactor=M-APIntraSetTimer/M-APInterSetTimer. In an embodiment, M-APIntraSetTimer=M-APFairnessFactor*M-APInterSetTimer may be considered as the fraction of M-APInterSetTimer period for which the respective Shared AP cannot participate in future coordinated transmissions (for example {0, ¼, ½, 1} for different M-APFairnessFactors). A zero value of the M-APFairnessFactor means no restriction on participating in coordinated transmissions.

As already described above, in a further embodiment, the second fairness timer, i.e. the M-APIntraSetTimer 240, 260 defines the period during which the respective AP cannot participate as a Shared AP in future coordinated transmissions. In an embodiment, M-APInterSetTimer=M-APFairnessFactor*M-APIntraSetTimer may be considered as the multiple of the M-APIntraSetTimer period during which the respective AP should hold, i.e. maintain the backoff counter (for example {1,2,4,8} for different M-APFairnessFactors).

In an embodiment, one or more parameters related to the embodiments described above may be indicated within a M-AP EDCA Information Element. More specifically, in an embodiment, the M-AP EDCA Information Element may include at least: the first fairness timer, i.e. the M-APInterSetTimer; the second fairness timer, i.e. the M-APIntraSetTimer; the fairness factor (if the two timers are correlated); a minimum size of a M-AP contention window; a maximum size of a M-AP contention window; a M-AP Arbitration Interframe Space Number, AIFSN; and/or a fairness timer initializing point.

In an embodiment, the M-AP EDCA Information Element may be included in a Coordination Agreement frame exchanged between the APs during the agreement establishment process on the parameters of the first and/or second fairness timer. In an embodiment, the parameters may be valid during the coordination agreement period.

According to a further embodiment, the M-AP EDCA Information Element may be included in the M-AP announcement frame. In other words, at the beginning of a TXOP the Sharing AP may include the parameters in the M-AP announcement frame to ensure every Shared AP that participates the M-AP coordinated transmission, uses the same parameters. In an embodiment, the parameters may be valid for a current TXOP. As will be appreciated, this embodiment also covers the case where a Coordination Agreement does not exist.

In an embodiment, each AP 120, 130, 140 when operating as a Shared AP may be configured to operate in accordance with one or more of the following rules: (i) each Shared AP 120, 130, 140 that has transmitted as part of a coordinated transmission triggered by the Sharing AP 110, sets its internal timer to the value of the first fairness timer, i.e. the M-APInterSetTimer in accordance with the M-AP Fairness Timers Initialization options described above; (ii) the EDCA backoff counter of the respective Shared AP 120, 130, 140 may be resumed only when the first fairness timer, i.e. the M-APInterSetTimer value reaches zero; (iii) an AP, which is a member of M-AP set 125 and/or a coordination agreement thereof, should not approve any participation within a coordinated transmission as a Shared AP if its M-APIntraSetTimer>0; (iv) once the Sharing AP 110 completes the M-AP Coordination transmission for the obtained TXOP, it may be configured to generate a new backoff value using the parameters M-APCWmin and M-APCWmax; and/or (v) if triggered, a respective AP may respond to management polls transmitted by the Sharing AP 110 during the entire first fairness timer, i.e. M-APInterSetTimer period.

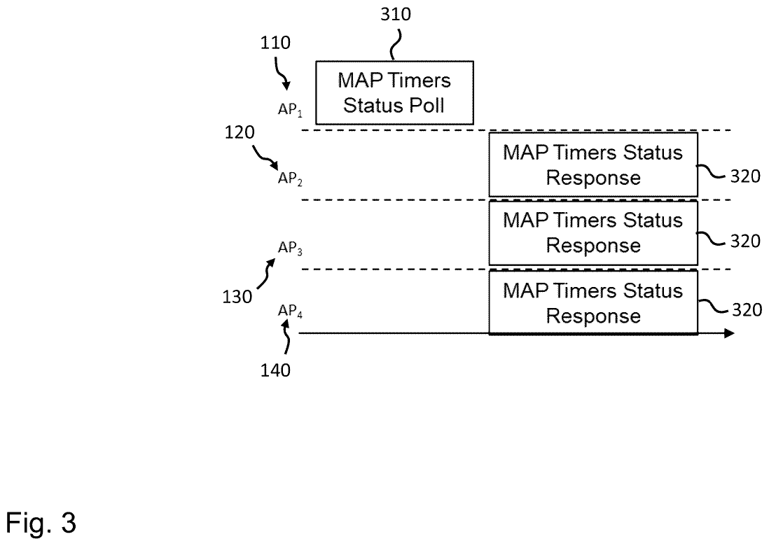

In an embodiment, each AP 110, 120, 130, 140 within the M-AP set 125 and/or a coordination agreement thereof is responsible for maintaining its own M-AP EDCA parameters. Thus, in order to allow the Sharing AP to decide which AP can potentially become a Shared AP, it may transmit a poll frame 310, as illustrated in FIG. 3, in order to get a short response from all other APs operating under the same Coordination Agreement within the M-AP set 125. In an embodiment, the APs may reply with a True/False answer (i.e. True if the second fairness timer, i.e. the M-APIntraSetTimer 250 counter already reached zero).

In an embodiment, the M-AP Timer Status poll frame 310 may be part of a M-AP announcement frame or transmitted by the Sharing AP 110 as standalone frame. The Sharing AP 110 may be configured to propose participating in a coordinated transmission only to those APs within the M-AP set 125 and/or a coordination agreement thereof that have responded with YES or True in a M-AP Timer Status Response frame 320 to the preceding M-AP Timer Status poll frame 310. In an embodiment, the M-AP Timer Status poll frame 310 issued by the Sharing AP 110 may include one or more of the following information elements: a M-AP Set ID; a Coordination agreement ID; and/or an AP ID List.

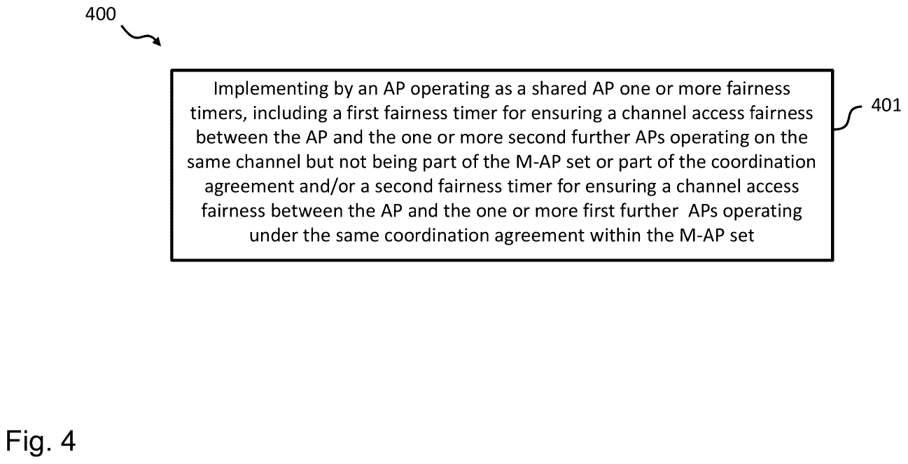

FIG. 4 is a flow diagram illustrating a method 400 of operating an AP, such as the AP 120 configured to gain channel access by participating in a coordinated transmission 220a making use of at least a portion of at least one transmission opportunity, TXOP, 210a obtained and shared by the Sharing AP 110 operating under a coordination agreement and/or within the M-AP 125 of the wireless communication network 100. The method 400 comprises a step 401 of implementing one or more fairness timers, including a first fairness timer 250 for ensuring a channel access fairness between the AP 120 and the one or more second further APs 150, 160, 170 operating on the same channel but not being part of the M-AP set 125 or part of the coordination agreement within the M-AP set 125 and/or a second fairness timer 240, 260 for ensuring a channel access fairness between the AP 120 and the one or more first further APs 130, 140 operating under the same coordination agreement within the M-AP set 125.

As the method 400 can be implemented, for instance, by the AP 120, when being operated as Shared AP 120, further features of the method 400 result directly from the functionality of the Shared AP 120 and its different embodiments described above and below.

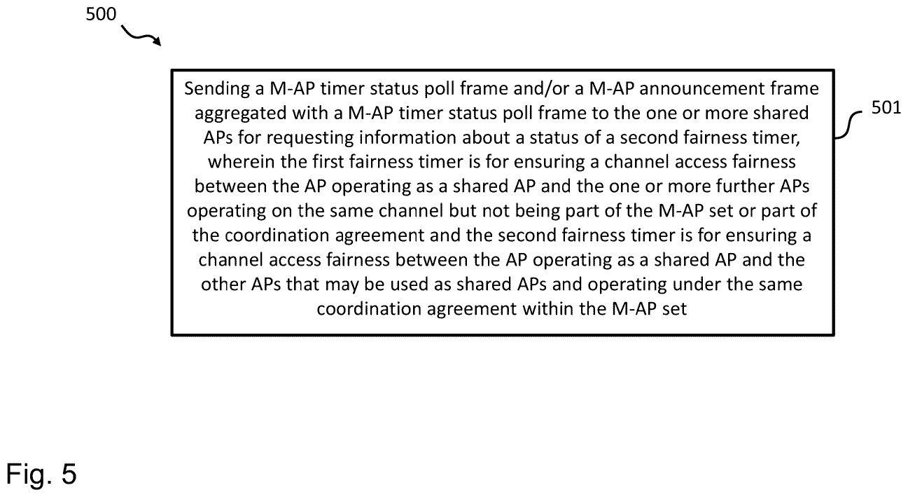

FIG. 5 is a flow diagram illustrating a method 500 of operating the AP 110, operating as Sharing AP 110, configured to manage channel access by one or more first further APs 120, 130, 140 by participating in a coordinated transmission 220a making use of at least a portion of at least one transmission opportunity, TXOP, 210a obtained and shared by the AP 110, operating as the Sharing AP 110, operating under a coordination agreement and/or within a M-AP set 125 of the wireless communication network 100. As already described above, each of the one or more first further APs 120, 130, 140 is configured to implement one or more fairness timers, including a first fairness timer 250 for ensuring a channel access fairness between the AP 120, 130, 140 and one or more second further APs 150, 160, 170 operating on the same channel but not being part of the M-AP set 125 or part of the coordination agreement within the M-AP set 125 and/or a second fairness timer 240, 260 for ensuring a channel access fairness between the AP 120, 130, 140 and the other first further APs 120, 130, 140 operating under the same coordination agreement within the M-AP set 125. The method 500 comprises a step 501 of sending a M-AP timer status poll frame 310 (as illustrated in FIG. 3) and/or a M-AP announcement frame aggregated with a M-AP timer status poll frame 310 to the one or more first further APs 120, 130, 140 for requesting information 320 about the second fairness timer 240, 260.

As the method 500 can be implemented by the AP 110, operating as Sharing AP 110, further features of the method 500 result directly from the functionality of the AP, operating as the Sharing AP 110, and its different embodiments described above and below.

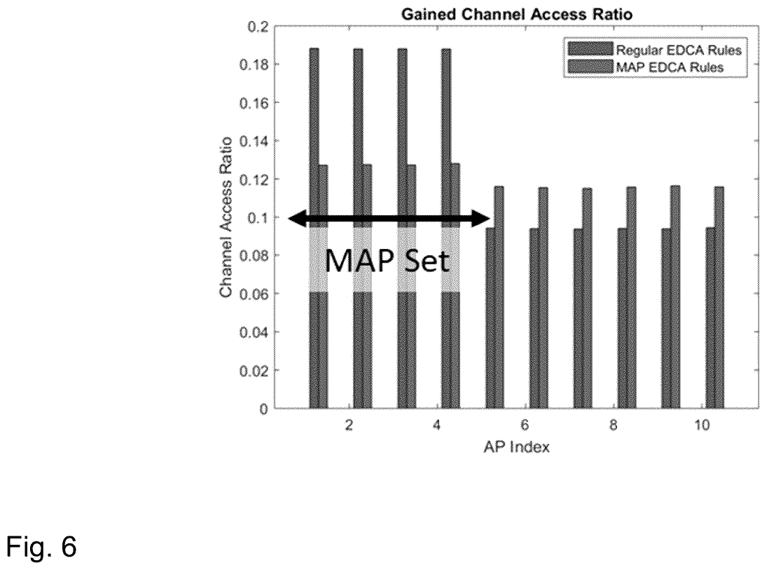

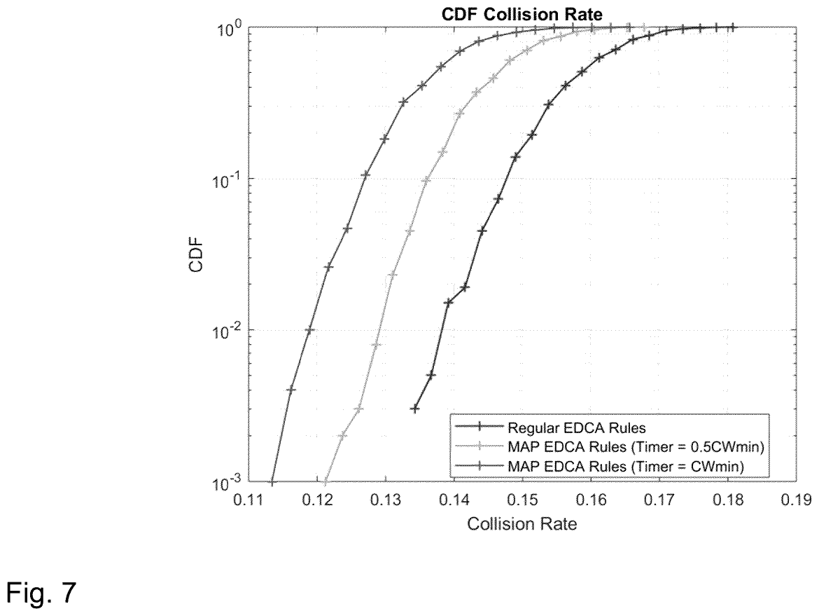

In the following simulation results obtained for multiple APs implementing the first fairness timer 250 and/or the second fairness timer 240, 260 will be described in the context of FIGS. 6, 7 and 8. These simulations have been performed for an exemplary Wi-Fi network 100 with 10 OBSS APs where 4 of them (AP indices 1-4 in FIG. 6) establish a M-AP set 125 and/or a M-AP Coordination agreement within the M-AP set 125 and a comparison was made between a scenario where regular EDCA rules were used for all OBSS APs and a scenario where the first fairness timer, i.e. the M-APInterSetTimer 250 was applied among AP1-AP4 when they were used as shared APs, while for the remaining OBSS APs regular EDCA rules were applied. As can be taken from FIGS. 6 and 7, applying the first fairness timer, i.e. the M-APInterSetTimer 250 for APs 1-4 (i.e. within the M-AP set 125) leads to fewer collisions and also reduces the “unfairness gap” between APs within the M-AP set 125 and the rest of the OBSS APs.

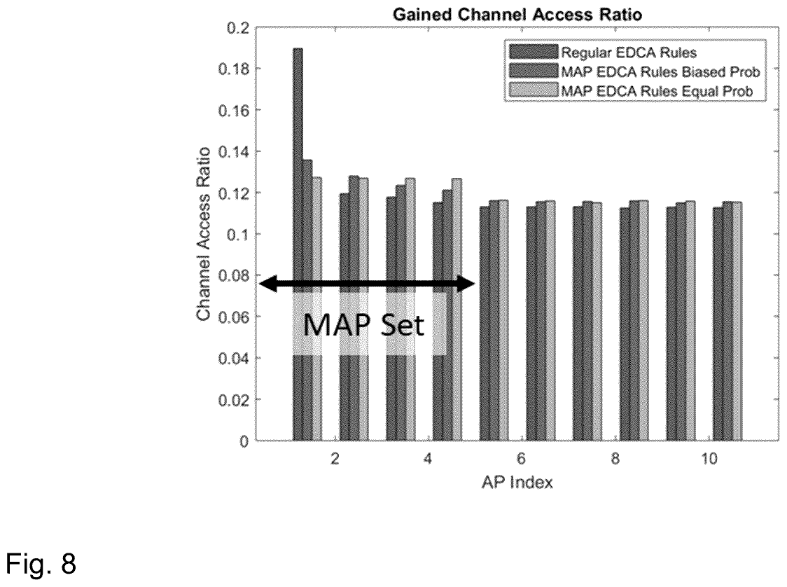

Concerning the Intra Set Fairness a similar simulation has been performed, which assumes the same Wi-Fi network 100 with 10 OBSS APs where 4 of them (AP indices 1-4 in FIG. 8) establish a M-AP set 125 and/or a M-AP Coordination agreement within M-AP set 125. For this simulation the APs within the M-AP set 125 are implementing the M-AP rules described above, i.e. the M-APInterSetTimer has a nonzero value, whereas the remaining OBSS APs operate in accordance with the conventional EDCA rules. Moreover, two algorithms for Shared AP selection have been employed, namely one with equal probability and one with higher probability for an AP with lower index to be selected (i.e. AP1). Both selection algorithms have been run initially with no second fairness timer, i.e. M-APIntraSetTimer applied resulting in a very non-equal channel access ratio. Indeed AP1 gained more channel access opportunities than other APs within the M-AP set, as can be taken from the respective left bars that represent the algorithm with non-equal probability in FIG. 8. When the second fairness timer, i.e. the M-APIntraSetTimer 240, 260 was applied (for this simulation it was assumed that the duration of the second fairness timer is equal to ¼ of CWMin duration) the difference between the APs within the M-AP set 125 decreased (i.e. has been balanced) resulting in a channel access ratio similar to an algorithm with equal probability (as illustrated by the respective middle and right bars in FIG. 8).

The person skilled in the art will understand that the “blocks” (“units”) of the various figures (method and apparatus) represent or describe functionalities of embodiments of the present disclosure (rather than necessarily individual “units” in hardware or software) and thus describe equally functions or features of apparatus embodiments as well as method embodiments (unit=step).

In the several embodiments provided in the present application, it should be understood that the disclosed system, apparatus, and method may be implemented in other manners. For example, the described embodiment of an apparatus is merely exemplary. For example, the unit division is merely logical function division and may be another division in an actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments disclosed herein may be integrated into one processing unit, or each of the units may exist alone physically, or two or more units are integrated into one unit.

1. An access point, (AP), configured to gain channel access by participating in a coordinated transmission making use of at least a portion of at least one transmission opportunity; (TXOP), obtained and shared by a Sharing AP, operating under a coordination agreement and/or operating within a Multi-AP (M-AP) set of a wireless communication network, the wireless communication network further including one or more first further APs being part of the M-AP set and/or operating under the coordination agreement, the AP comprising:
processing circuitry configured to:
implement one or more fairness timers, including:
a first fairness timer for ensuring a channel access fairness between the AP and one or more second further APs operating on a same channel but not being part of the M-AP set or of the same coordination agreement or another coordination agreement, and/or
a second fairness timer for ensuring a channel access fairness between the AP and the first further APs operating under the same coordination agreement and/or being part of the M-AP set.

2. The AP of claim 1, the processing circuitry being configured to:
implement the first fairness timer after being shared for a coordinated transmission by the Sharing AP, that has obtained the TXOP for ensuring the channel access fairness between the AP and the one or more second further APs; and
wait for the first fairness timer to end its counting before resuming competing for gaining the channel access.

3. The AP of claim 1, the processing circuitry being configured to:
implement the second fairness timer for ensuring the channel access fairness between the AP and the first further APs, and
wait for the second fairness timer to end before participating in another coordinated transmission within the M-AP set or under the same coordination agreement within the M-AP set.

4. The AP of claim 1, wherein the first fairness timer and/or the second fairness timer are defined by the coordination agreement.

5. The AP of claim 1, wherein prior to or at the beginning of the TXOP, the processing circuitry is configured to receive a frame from the Sharing AP, wherein the frame comprises an indication for the AP whether to count for the second fairness timer before participating in another coordinated transmission initiated by any AP operating under the coordination agreement or operating in the M-AP set.

6. The AP of claim 1, wherein a ratio of a value of the first fairness timer to a value of the second fairness timer or a ratio of a value of the second fairness timer to a value of the first fairness timer is defined by a fairness factor.

7. The AP of claim 1, the AP is configured to send information to the Sharing AP indicative of whether the second fairness timer has expired.

8. A method of operating an access point, (AP) configured to gain channel access by participating in a coordinated transmission making use of at least a portion of at least one transmission opportunity (TXOP) obtained and shared by a Sharing AP, operating under a coordination agreement and/or operating within a Multi-AP (M-AP) set of a wireless communication network, the wireless communication network further including one or more first further APs being part of the M-AP set and/or operating under the coordination agreement, the method comprising:
implementing one or more fairness timers, including:
a first fairness timer for ensuring a channel access fairness between the AP and one or more second further APs operating on a same channel but not being part of the M-AP set or of the coordination agreement or another coordination agreement, and/or
a second fairness timer for ensuring a channel access fairness between the AP and the one or more first further APs operating under the same coordination agreement within the M-AP set.

9. A Sharing AP operating under a coordination agreement and/or operating within a Multi-AP (M-AP) set of a wireless communication network, the wireless communication network further including one or more first further APs, comprising:
processing circuitry configured to manage channel access by one or more first further APs by participating in a coordinated transmission making use of at least a portion of at least one transmission opportunity (TXOP) obtained and shared by the Sharing AP, wherein each of the one or more first further APs is configured to implement one or more fairness timers, including a first fairness timer for ensuring a channel access fairness between the first further AP and one or more second further APs operating on the same channel but not being part of the M-AP set or of the coordination agreement and/or a second fairness timer for ensuring a channel access fairness between the first further AP and other first further APs operating under the same coordination agreement; and
send a M-AP timer status poll frame and/or a M-AP announcement frame aggregated with a M-AP timer status poll frame to the one or more first further APs for requesting information about the second fairness timer.

10. The AP of claim 9, wherein the M-AP timer status poll frame and/or the M-AP announcement frame comprises a M-AP set identifier indicative of the M-AP set.

11. The AP of claim 9, wherein the M-AP timer status poll frame and/or the M-AP announcement frame comprises a coordination agreement identifier, wherein the coordination agreement identifier identifies one coordination agreement of a plurality of coordination agreements within the M-AP set, and wherein the Sharing AP, and the one or more first further APs operate under the coordination agreement identified by the coordination agreement identifier within the M-AP set.

12. The AP of claim 9, wherein the M-AP timer status poll frame and/or the M-AP announcement frame comprises one or more identifiers indicative of the first further APs requested to send a M-AP timer status response frame to the Sharing AP.

13. The AP of claim 9, wherein the Sharing AP, is configured to receive a M-AP timer status response frame from the one or more first further APs, wherein the M-AP timer status response frame comprises information about the second fairness timer.

14. A method of operating a sharing AP, operating under a coordination agreement and/or operating within a Multi-AP (M-AP) set of a wireless communication network, the wireless communication network further including one or more first further APs, the method comprising:
managing channel access by one or more first further APs by participating in a coordinated transmission making use of at least a portion of at least one transmission opportunity (TXOP) obtained and shared by the Sharing AP, wherein each of the one or more first further APs is configured to implement one or more fairness timers, including a first fairness timer for ensuring a channel access fairness between the AP and one or more second further APs operating on the same channel but not being part of the M-AP set or of the coordination agreement and/or a second fairness timer for ensuring a channel access fairness between the AP and other first further APs operating under the same coordination agreement within the M-AP set, and
sending a M-AP timer status poll frame and/or a M-AP announcement frame aggregated with a M-AP timer status poll frame to the one or more first further APs for requesting information about the second fairness timer.

15. A non-transitory computer-readable medium comprising a computer program comprising a program code for performing the method of operating an access point (AP) configured to gain channel access by participating in a coordinated transmission making use of at least a portion of at least one transmission opportunity (TXOP) obtained and shared by a Sharing AP, operating under a coordination agreement and/or within a Multi-AP, (M-AP), set of a wireless communication network, the wireless communication network further including one or more first further APs being part of the M-AP set and/or operating under the coordination agreement, wherein the method comprises:
implementing one or more fairness timers, including:
a first fairness timer for ensuring a channel access fairness between the AP and one or more second further APs operating on a same channel but not being part of the M-AP set or part of the coordination agreement or another coordination agreement, and/or a second fairness timer for ensuring a channel access fairness between the AP and the one or more first further APs operating under the same coordination agreement within the M-AP set.
